(19) United States
(12) Patent Application Publication
(10) Pub. No.: US 2025/0378130 A1
(43) Pub. Date: Dec. 11, 2025

(54) OPTIMIZATION SYSTEM, OPTIMIZATION METHOD, AND OPTIMIZATION PROGRAM

(71) Applicant: Hitachi Vantara, Ltd., Yokohama-shi (JP)

(72) Inventors: Mizuki ITO, Tokyo (JP); Kazuo ONO, Tokyo (JP)

(21) Appl. No.: 19/075,961

(22) Filed: Mar. 11, 2025

(30) Foreign Application Priority Data
Jun. 10, 2024 (JP) 2024-093963

(51) Int. Cl. G06F 17/11

(52) U.S. Cl. CPC G06F 17/11

(57) ABSTRACT

An annealing unit uses a first solver to perform a first search for an annealing solution through lowering of an objective function value in the neighborhood of a constraint satisfying solution, a mixed integer programming problem optimization unit uses a second solver to perform a second search for a constraint satisfying solution through lowering of a value of an objective function of a linear expression in the neighborhood of the annealing solution obtained by the annealing unit, and iterative processing of the first search and the second search is performed to obtain an optimal solution.

### CROSS-REFERENCE TO RELATED APPLICATION

The present application claims priority from Japanese application JP2024-093963, filed on Jun. 10, 2024, the content of which is hereby incorporated by reference into this application.

### BACKGROUND OF THE INVENTION

### 1. Field of the Invention

The present invention relates to an optimization system, an optimization method, and an optimization program.

### 2. Description of the Related Art

As a method for searching for an optimal solution of an optimization problem, a solving method using the alternating direction method of multipliers (ADMM) to solve a constrained mixed binary quadratic programming problem is known. To solve a linear inequality constrained mixed binary quadratic programming problem having linear inequality constraint, JP 2023-121046 A discloses a method of alternately executing an optimization algorithm (optimization method such as an annealing method) for efficiently solving a quadratic unconstrained binary optimization (QUBO) and a continuous optimization algorithm involving a Hildreth algorithm for an augmented Lagrangian function in ADMM.

With ADMM, a problem can be solved efficiently using a suitable optimization method for each element of the problem.

JP 2023-121046 A proposes a solution using ADMM as a technique to satisfy a linear inequality constraint in annealing, and discloses a method for solving a mixed binary quadratic programming problem in which a linear inequality constraint is satisfied by processing the constraint by a Hildreth algorithm using ADMM incorporating annealing and the Hildreth algorithm using the Lagrangian function method.

### SUMMARY OF THE INVENTION

In ADMM under a general condition, an feasible solution is not always found at the end. To find an feasible solution, the Feasibility Pump method is used as a heuristic for an optimization problem in which a result of a continuous value is rounded to an integer.

In a solving method using ADMM disclosed in JP 2023-121046 A to solve a mixed binary quadratic programming problem, more specifically, “annealing” processing is performed in the first block and “Hildreth algorithm” processing is performed in the second block to find an feasible solution by the Feasibility Pump method based on the optimal solution obtained in the second block. This is however disadvantageous in that it takes calculation time until the solution converges in the execution processing of the Hildreth algorithm and the Feasibility Pump method, and it is thus difficult to obtain a high-quality solution at a high speed.

The present invention has been made in view of such a background. For a mixed binary quadratic programming problem having a linear constraint which is difficult to be satisfy by annealing alone, an object of the present invention is to speed up convergence to an optimal solution also in the second block by considering a linear objective function in the second block of ADMM while not performing linear relaxation on integer variables and handling the integers to maintain their integer properties.

### Solution to Problem

An optimization system according to one aspect of the present invention is an optimization system that searches for an optimal solution of a mixed binary quadratic programming problem having a constraint condition, the optimization system including an annealing unit that performs a first search for an annealing solution through lowering of a value of an objective function of the mixed binary quadratic programming problem, and a mixed integer programming problem optimization unit that performs a second search for a satisfying solution satisfying the constraint condition through lowering of a value of an objective function of a linear expression in the mixed binary quadratic programming problem as the mixed integer programming problem, wherein the annealing unit performs using a first solver the first search for the annealing solution through lowering of the objective function value in the neighborhood of the satisfying solution, the mixed integer programming problem optimization unit performs using a second solver the second search for the satisfying solution in the neighborhood of the annealing solution obtained by the annealing unit, and iterative processing of the first search and the second search is performed to obtain the optimal solution.

In addition, the problem and the method for solving the problem disclosed in the present application will be clarified by the description of embodiments for carrying out the invention and the drawings.

### Advantageous Effects of Invention

According to the present invention, a high-quality solution is derived at a high speed for a mixed binary quadratic programming problem having a linear constraint that is difficult to be satisfy by annealing alone. In addition, by not performing linear relaxation for integer variables to handle the integers to maintain their integer properties, convergence to an optimal solution can be sped up also in the second block by considering the linear objective function in the second block of ADMM.

### BRIEF DESCRIPTION OF DRAWINGS

FIG. 1 is a conceptual diagram illustrating a relationship between a variable arrangement and an objective function value of an optimization problem;

FIG. 2 is a diagram illustrating a functional configuration of an optimization system according to an embodiment;

FIG. 3 is a diagram illustrating a hardware configuration of the optimization system according to the embodiment; and

FIG. 4 is a flowchart of optimization processing in the optimization system according to the embodiment.

### DESCRIPTION OF EMBODIMENTS

Hereinafter, embodiments will be described with reference to the drawings. The embodiments and the drawings are examples for describing the present invention. In the embodiments, omission and simplification are appropriately made for clarity of description. Unless otherwise specified, the number of each component in the embodiment may be one or more.

The same or similar components are denoted by the same reference numeral, and the description already made for an embodiment may be omitted or made mainly on differences for the later described embodiment.

When there is a plurality of the same or similar components, those components may be described with the same reference numeral with different subscripts. When such a plurality of components needs not be distinguished, subscripts may be omitted in the description.

In the embodiment, processing performed by executing a program may be described. A computer performs processing defined by a program and performed by a processor (for example, a central processing unit (CPU) or a graphics processing unit (GPU)) using a storage resource (for example, a memory) or the like.

Therefore, the subject of the processing performed by executing a program may be a processor. Similarly, the subject of the processing performed by executing a program may be a controller, a device, a system, a computer, or a node including a processor. The subject of the processing performed by executing a program may be any arithmetic unit, and may include a dedicated circuit that performs specific processing.

The dedicated circuit is, for example, a field programmable gate array (FPGA), an application specific integrated circuit (ASIC), or a complex programmable logic device (CPLD).

The program may be installed on a computer from a program source. The program source may be, for example, a non-transitory storage medium readable by a program distribution server or a computer. When the program source is a program distribution server, the program distribution server may include a processor and a storage resource (storage) that stores a program to be distributed, and the processor of the program distribution server may distribute the program to be distributed to another computer.

In addition, in the embodiment, two or more programs may be implemented as a single program, or a single program may be implemented as two or more programs.

In the following description, for example, the notation “A˜” is equivalent to the notation in which “˜” is put immediately above “A”.

In the following embodiments, in a system configuration for example, components other than main components such as a processor and a memory will not be illustrated nor described, and description will be made mainly for elements and processing related to the technology of the present disclosure.

The following Equation 1 is a constrained mixed binary quadratic programming problem. There are N variables, x₁, . . . , and x_{N}, in an optimization problem, and a domain Di of each variable xi is either a binary value {−1, +1} or a continuous value [−1, +1]. Which value the domain Di of variable xi takes is determined depending on each problem. An objective function H0 of the optimization problem is expressed by Equation 1. That is, the objective function H is expressed by a quadratic expression including the variable x. In addition, in Equation 1, x=[x₁, . . . , x_{N}] is an N-dimensional vector, J is an N by N symmetric matrix, and h is an N-dimensional vector. ξ(x)≤0 represents an inequality constraint to be satisfied by x.

$${min .}_{x ∈ 𝒳} {H}_{0} ( x ) where {H}_{0} ( x ) := - \frac{1}{2} {x}^{⊤} 𝒥 x - {𝒽}^{⊤} x subject to ξ ( x ) \leq 0 \qquad [ Equation 1 ]$$

First, in this method, the objective function H0(x) of the constrained mixed binary quadratic programming problem is reformulated into an objective function term including a quadratic expression and an objective function term including only a linear expression as expressed in Equation 2.

$${H}_{0} ( x ) = {F}^{2} ( x ) + {F}^{1} ( x ) \qquad [ Equation 2 ]$$

F2(x) is an objective function term including a quadratic expression, and F1(x) is an objective function term including only a linear expression. Using F2(x) and F1(x), H(x) and φ(x) are defined as follows.

$${H}_{0} ( x ) = H ( x ) + ϕ ( x ) \qquad [ Equation 3 ]$$

$$H ( x ) = {F}^{2} ( x ) + α {F}^{1} ( x ) \qquad [ Equation 4 ]$$

$$ϕ ( x ) = ( 1 - α ) {F}^{1} ( x ) \qquad [ Equation 5 ]$$

α takes a range of [0, 1]. From the above equations, the objective function in Equation 1 can be rewritten into the following Equation 6.

$$min H ( x ) + ϕ ( x ) \qquad [ Equation 6 ]$$

Next, a solving method of the constrained mixed binary quadratic programming problem using the alternating direction method of multipliers will be described. The following Equation 7 will be discussed, using the already described Equation 6, as a constrained mixed binary quadratic programming problem.

$${min .}_{x ∈ 𝒳} \{ H ( x ) + ϕ ( x ) \} where H ( x ) := - \frac{1}{2} {x}^{⊤} 𝒥 x - {𝒽}^{⊤} x subject to ξ ( x ) \leq 0 \qquad [ Equation 7 ]$$

The function φ is a linear function. A set X:={{xi}i=1, . . . , n|xi∈Di} has a set Di which is a closed section. This formulation includes QUBO (quadratic unconstrained binary optimization (unconstrained binary quadratic optimization problem)) and mixed binary quadratic programming (QP) (mixed binary quadratic programming problem). An indicator function IS for a set S is defined as follows.

$${I}_{S} ( x ) = \{ \begin{matrix}0 & x ∈ S \\ ∞ & Otherwise\end{matrix} \qquad [ Equation 8 ]$$

The function φ is independent of the function H and has a vector X˜ as a variable, where the set X˜:={x˜∈Rⁿ|ξ(x˜)≤0} is a convex set. ξ(x˜) may be a linear function of x˜, and thus x˜ is not always a closed set.

Equation 8 can be expressed using Equation 7 as follows.

$${min}_{x ∈ ℝ , \tilde{x} ∈ ℝ , y ∈ ℝ} \{ H ( x ) + {I}_{χ} ( x ) + ϕ ( \tilde{x} ) + {I}_{\tilde{χ}} ( \tilde{x} ) + \frac{γ}{2} {‖ y ‖}^{2} \} subject to {A}_{1} x + {A}_{2} x + By = 0 \qquad [ Equation 9 ]$$

In Equation 9, A1:=In, A2:=−In, and B:=−In (In is an identity matrix).

The following augmented Lagrangian function is defined based on Equation 9. Here, the first to fifth terms on the right-hand side corresponds to the objective function, a polynomial in the sixth term corresponds to a constraint expression, and the seventh term corresponds to a penalty term based on the constraint expression.

$${ℒ}_{\text{?}} ( x , \tilde{x} , y , λ ) := H ( x ) + {I}_{χ} ( x ) + ϕ ( \tilde{x} ) + {I}_{\tilde{χ}} ( \tilde{x} ) + \frac{γ}{2} {‖ y ‖}^{2} + {λ}^{T} ( {A}_{1} x + {A}_{2} \tilde{x} + By ) + \frac{ρ}{2} {‖ {A}_{1} x + {A}_{2} \tilde{x} + By ‖}^{2} \qquad [ Equation 10 ]$$

$$\text{?} \text{indicates text missing or illegible when filed}$$

It is known that, when the following optimization calculation is iterated according to ADMM, x and x˜ converge to a certain point when ρ is sufficiently large as expressed by Equations 11.

$$\begin{matrix}x ← arg {min}_{x ∈ {ℝ}^{n}} {ℒ}_{ρ} ( x , \tilde{x} , y , λ ) \\ \tilde{x} ← arg {min}_{\tilde{x} ∈ {ℝ}^{n}} {ℒ}_{ρ} ( x , \tilde{x} , y , λ ) \\ y ← arg {min}_{y ∈ {ℝ}^{n}} {ℒ}_{ρ} ( x , \tilde{x} , y , λ )\end{matrix} \qquad [ Equation 11 ]$$

Hereinafter, a specific calculation method of Equations 11 will be described. The first equation in Equations 11 can be transformed into Equation 12. Defining that in Equation 7 that the coefficient matrix of the quadratic term is J˜:=J−ρI and the coefficient vector of the linear term is h˜:=h+ρ(x˜+y)−λ, the first equation in Equations 11 represents an unconstrained mixed binary quadratic programming problem where x˜ is fixed and x is variable. Note that, I is an identity matrix.

$$\begin{matrix}{arg min}_{x ∈ χ} {ℒ}_{ρ} ( x , \tilde{x} , y , λ ) = {arg min}_{x ∈ {ℝ}^{n}} [ H ( x ) + {I}_{χ} ( x ) + ϕ ( x ) + {I}_{\tilde{χ}} ( \tilde{x} ) + \frac{γ}{2} {‖ y ‖}^{2} + {λ}^{⊤} ( {A}_{1} x + {A}_{2} \tilde{x} + By ) + \frac{ρ}{2} {‖ {A}_{1} x + {A}_{2} \tilde{x} + By ‖}^{2} ] \\ = {arg min}_{x ∈ χ} [ H ( x ) + {λ}^{⊤} x + \frac{ρ}{2} {x}^{⊤} x - {ρ ( \tilde{x} + y )}^{⊤} x ] \\ = {arg min}_{x ∈ χ} [ H ( x ) + \frac{ρ}{2} {x}^{⊤} x - {( ρ ( \tilde{x} + y ) - λ )}^{⊤} x ] \\ = {arg min}_{x ∈ χ} [ - \frac{1}{2} {x}^{⊤} \tilde{J} x - {\tilde{h}}^{⊤} x ]\end{matrix} \qquad [ Equation 12 ]$$

The second equation in Equations 11 can be expressed as Equation 13 using a vector c=x−y+λ/ρ. Here, x is immediately obtained from the first equation in Equations 11. That is, the second equation in Equations 11 represents a constrained mixed binary quadratic programming problem where x˜ is fixed and x is variable.

$$\begin{matrix}{arg min}_{\tilde{x} ∈ ℝ} {ℒ}_{ρ} ( x , \tilde{x} , y , λ ) = {arg min}_{\tilde{x} ∈ {ℝ}^{n}} [ H ( x ) + {I}_{χ} ( x ) + ϕ ( \tilde{x} ) + {I}_{\tilde{χ}} ( \tilde{x} ) + \frac{γ}{2} {‖ y ‖}^{2} + {λ}^{⊤} ( {A}_{1} x + {A}_{2} \tilde{x} + By ) + \frac{ρ}{2} {‖ {A}_{1} x + {A}_{2} \tilde{x} + By ‖}^{2} ] \\ = {arg min}_{\tilde{x} ∈ χ} [ ϕ ( x ) - {λ}^{⊤} x + \frac{ρ}{2} {‖ x - \tilde{x} - y ‖}^{2} ] \\ = {arg min}_{\tilde{x} \vert ξ ( \tilde{x} ) \leq 0} [ ϕ ( \tilde{x} ) - {λ}^{⊤} \tilde{x} + \frac{ρ}{2} {‖ \tilde{x} - ( x - y ) ‖}^{2} ] \\ = {arg min}_{\tilde{x} \vert ξ ( \tilde{x} ) \leq 0} [ ϕ ( \tilde{x} ) + {\sum }_{i = 1}^{n} \{ \frac{ρ}{2} {\tilde{x}}_{i}^{2} - ( ρ ( {x}_{i} - {y}_{i} ) + {λ}_{i} ) {\tilde{x}}_{i} \} ] \\ = {arg min}_{\tilde{x} \vert ξ ( \tilde{x} ) \leq 0} [ \frac{2}{ρ} \cdot ϕ ( \tilde{x} ) + {\sum }_{i = 1}^{n} \{ {\tilde{x}}_{i}^{2} - 2 ( {x}_{i} - {y}_{i} + \frac{{λ}_{i}}{ρ} ) {\tilde{x}}_{i} \} ] \\ = {arg min}_{\tilde{x} \vert ξ ( \tilde{x} ) \leq 0} ( {‖ \tilde{x} - c ‖}_{1} + \frac{2}{ρ} \cdot ϕ ( \tilde{x} ) )\end{matrix} \qquad [ Equation 13 ]$$

The third equation in Expressions 11 is a calculation expression for updating a vector y using x and x˜ immediately obtained from the first and second equations in Equations 11 and a vector λ that is before the update.

$$\begin{matrix}{arg min}_{y ∈ {ℝ}^{n}} {ℒ}_{ρ} ( x , \tilde{x} , y , λ ) = {arg min}_{y ∈ {ℝ}^{n}} [ H ( x ) + {I}_{χ} ( x ) + ϕ ( \tilde{x} ) + {I}_{\tilde{χ}} ( \tilde{x} ) + \frac{γ}{2} {‖ y ‖}^{2} + {λ}^{⊤} ( {A}_{1} x + {A}_{2} \tilde{x} + By ) + \frac{ρ}{2} {‖ {A}_{1} x + {A}_{2} \tilde{x} + By ‖}^{2} ] \\ = {arg min}_{y ∈ {ℝ}^{n}} [ \frac{γ}{2} {‖ y ‖}^{2} - {λ}^{⊤} y + \frac{ρ}{2} {‖ x - \tilde{x} - y ‖}^{2} ] \\ = {arg min}_{y ∈ {ℝ}^{n}} {\sum }_{i = 1}^{n} [ \frac{γ}{2} {y}_{i}^{2} - {λ}_{i} {y}_{i} + \frac{ρ}{2} {( {y}_{i} - ( {x}_{i} - {\tilde{x}}_{i} ) )}^{2} ] \\ = {arg min}_{y ∈ {ℝ}^{n}} {\sum }_{i = 1}^{n} [ \frac{γ + ρ}{2} {y}_{i}^{2} - ( {λ}_{i} + ρ ( {x}_{i} - {\tilde{x}}_{i} ) ) {y}_{i} ]\end{matrix} \qquad [ Equation 14 ]$$

Equation 14 is obtained analytically as follows.

$$y ← \frac{λ + ρ ( x - x )}{γ + ρ} \qquad [ Equation 15 ]$$

Equations 16 are update equations for calculating the parameters for the subsequent calculation in the iterative calculation described above. The parameters used in the (k+1)-th iterative calculation are calculated using the result of the k-th iterative calculation.

In Equations 16, f_{update} is a function of a parameter ρ used in the k-th iterative calculation, and may be a function of simply multiplying by one (which means that ρ takes the same value throughout the iterative calculation) or a function of multiplying the k-th ρ by a constant. A sufficiently large ρ improves convergence of solution, whereas an excessively large ρ inhibits global searching of solution and increases the possibility of convergence to a local optimal solution.

Therefore, effective update is performed by starting the calculation with ρ of a sufficiently small value and gradually increasing ρ. As is clear from Equation 10, when x=x˜ and y=0 are satisfied, the constraint is satisfied, it means that the solution has been converged.

Therefore, a function of updating ρ according to a change in the absolute value of y may also be effective. For example, such a function may be used that selects, according to the solution obtained in the k-th calculation, either of multiplying by a constant or multiplying by one to use the same value as that of the k-th calculation in the (k+1)-th calculation may be used.

$$\begin{matrix}{λ}^{k + 1} = {λ}^{k} + {ρ}^{k} ( {A}_{1} {x}_{1}^{k} + {A}_{2} {\tilde{x}}^{k} + {By}^{k} ) \\ {ρ}^{k + 1} = {f}_{update} ( {ρ}^{k} ) \\ {γ}^{k + 1} = {αρ}^{k}\end{matrix} \qquad [ Equation 16 ]$$

In the update equation of γ in Equations 16, α is desirably determined to take a value between 0 and 1. Empirically, a value is close to 1 improves convergence.

Here, functions ξ₁ (x˜), . . . , ξₘ (x˜) are convex. Functions ξ(x˜)=maxᵢ₋₁, . . . , ₘξ₁(x˜) are convex. Then, ξ₁ (x˜)≥0, . . . , ξₘ (x˜)≥0 [symbol] ξ(x˜)≤0 are satisfied. Hereinafter, a constraint expressed by a convex function will be discussed.

For a convex function ξₘ(x)=aᵢ^{x}−uᵢ having a finite real number uᵢ, ξ(x˜)≤0 [symbol] aᵢ^{T}x≤uᵢ is satisfied. For a convex function ξ₁ (x˜)=lᵢ−aᵢ^{T}x having a finite real number lᵢ, ξ(x˜)≤0 [symbol] lᵢ≤aᵢ^{T}x is satisfied.

Thus, for a convex function ξᵢ(x˜)=(aᵢ^{T}x−lᵢ)(aᵢ^{T}x−uᵢ) having a finite real number lᵢ and uᵢ, ξᵢ(x˜)≤0 [symbol] lᵢ≤aᵢ^{T}x≤uᵢ is satisfied.

Thus, the constraint of L≤Ax≤U can be handled as ξ(x˜)≤0. This constraint also includes an equality constraint and is an important inequality constraint involved in many real problems.

For Equation 13, substituting ξᵢ(x˜)≤0 with L≤Ax≤U and changing a portion of minimization of the square of L2 norm to a term of minimization of L1 norm gives Equation 17.

$$\begin{matrix}{arg min}_{\tilde{x} \vert ξ ( \tilde{x} ) \leq 0} ( {‖ \tilde{x} - c ‖}_{1} + \frac{2}{ρ} \cdot ϕ ( \tilde{x} ) ) & subject to L \leq Ax \leq U\end{matrix} \qquad [ Equation 17 ]$$

Equation 17 is input into the mixed integer programming solver (branch and bound method) to solve the second equation in Equations 11 by ADMM.

When solving the second block of ADMM (the second equation in Equations 11), Equation 13 can be rewritten into the following Equation 18.

$$\begin{matrix}{arg min}_{\tilde{x} \vert ξ ( \tilde{x} ) \leq 0} ( {\sum }_{i = 1}^{n} {T}_{i}^{2} + \frac{2}{ρ} \cdot ϕ ( \tilde{x} ) ) & {T}_{i} = {\tilde{x}}_{i} - {c}_{i}\end{matrix} \qquad [ Equation 18 ]$$

Changing a term in Equation 18 to a term of minimization of L1 norm will eventually solve Equation 19.

$$\begin{matrix}{arg min}_{\tilde{x} \vert ξ ( \tilde{x} ) \leq 0} ( {\sum }_{i = 1}^{n} {T}_{i}^{2} + \frac{2}{ρ} \cdot ϕ ( \tilde{x} ) ) & - {T}_{i} \leq {\tilde{x}}_{i} - {c}_{i} \leq {T}_{i}\end{matrix} \qquad [ Equation 19 ]$$

L2 norm is a square root of the sum of squares of the components of a vector. When solving an optimization problem so as to minimize L2 norm, the solution tends to take more uniform values. The solution also tends to be easily affected by outliers.

Meanwhile, L1 norm is the sum of the absolute values of the components of a vector. In solving an optimization problem so as to minimize L1 norm, the sparsity of the solution is promoted, which makes it less affected by outliers.

As a specific example, the present embodiment is effective, for example, when an objective function term including a quadratic expression and an objective function term including only a linear expression have the same optimal solution.

With reference to the solving method of the constrained mixed binary quadratic programming problem using ADMM in the present embodiment described above, the effectiveness of the present embodiment will be described.

For example, the following objective function is given.

$$min \sum {( {x}_{n} - {A}_{n} )}^{2} + \sum \vert {x}_{n} - {A}_{n} \vert \qquad [ Equation 20 ]$$

Here, H(x) in Equation 6 is a first term that is an objective function including a quadratic expression, and φ(x) is a second term that is an objective function including only a linear expression.

In the first block of ADMM (the first equation in Equations 11), the following Equation 21 is first solved to minimize the second-order objective function by annealing. Specifically, the unconstrained mixed binary quadratic programming problem expressed by Equation 12 is solved.

$$min . \sum {( {x}_{n} - {A}_{n} )}^{2} \qquad [ Equation 21 ]$$

Next, in the second block of ADMM (the second equation in Equations 11), the linear objective function term is minimized by the mixed integer programming solver (branch and bound method). Specifically, Equation 17, which is a mixed integer programming problem, is solved.

$$min . \sum \vert x - A \vert \qquad [ Equation 22 ]$$

Since Equation 21 and Equation 22 are connected by ADMM via L1 norm, the solution is minimized.

In solving the second block of ADMM, the sparsity of solution is promoted by changing the portion of minimization of the square of L2 norm to a term of minimization of L1 norm. The minimization of L1 norm is more robust to outliers.

From the above characteristics, minimization of L1 norm is effective when sparsity is desirable or when handling a data set including many outliers.

Problems to which the present embodiment can be applied include a compressed sensing problem and a feature selection problem.

Note that the Hamiltonian generated when handling a constraint expression by the penalty function method is put in H(x).

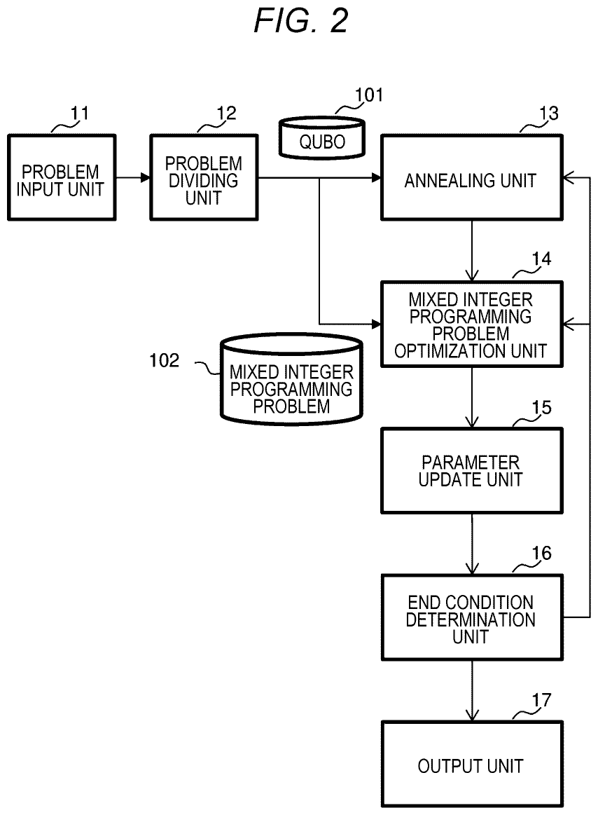

FIG. 2 is a diagram illustrating a functional configuration for implementing the optimization system according to the embodiment.

The optimization system includes functional blocks of a problem input unit 11, a problem dividing unit 12, an annealing unit 13, a mixed integer programming problem optimization unit 14, a parameter update unit 15, an end condition determination unit 16, and an output unit 17.

The problem input unit 11 has a function of inputting a mixed binary quadratic programming problem expressed by Equation 1 and Equation 7 to an information processing device. This function also involves inputting together the definition of a decision variable x and the definitions of various constraint conditions in a form of mathematical expression according to the problem to be solved.

The problem dividing unit 12 has a function of dividing the problem input by the problem input unit 11 into a mathematical formula to be solved by the annealing unit 13 and a mathematical formula to be solved by the mixed integer programming problem optimization unit 14 and outputting the divided mathematical formulas. Specifically, the QUBO equation 101 is output for the annealing unit 13, and the mixed integer programming problem 102 is output for the mixed integer programming problem optimization unit 14.

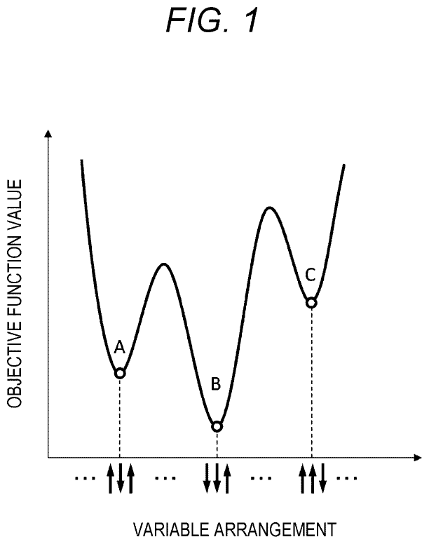

As illustrated in FIG. 1, the annealing unit 13 searches a solution to minimize energy along a state space. An algorithm used in this searching is an annealing method based on Markov Chain Monte Carlo method (MCMC). The problem solved by the annealing unit 13 is expressed by Equation 12. The QUBO equation 101 passed from the problem dividing unit 12 is represented by Jᵢⱼ or h in Equation 12.

The mixed integer programming problem optimization unit 14 is a functional block that solves the problem expressed by Equation 17 using the mixed integer programming problem 102 output from the problem dividing unit 12.

The objective function in the calculation in the mixed integer programming problem optimization unit 14 includes an objective function expressed by a linear expression derived by the augmented Lagrangian function method. In searching a solution for the decision variable x˜, a mixed integer programming solver such as a branch and bound method is used. Other than such solvers, any solver that operates according to an algorithm having a function of solving a mixed integer programming problem while handling an integer variable as it is may be used.

The parameter update unit 15 updates the update equation for y expressed by the third equation in Equations 11, λ, ρ, and γ. To use the updated parameters in the next iterative calculation, there are feedback paths to the annealing unit 13 and the mixed integer programming problem optimization unit 14. A single iterative calculation includes a series of calculations performed in a series of functional blocks of the annealing unit 13, the mixed integer programming problem optimization unit 14, the parameter update unit 15, and the end condition determination unit 16.

The end condition determination unit 16 determines, in response to the result of the parameter update unit 15, whether to perform the next iterative calculation or end the optimization calculation. The criterion for the determination is, for example, whether a predetermined number of times of iterative calculation is finished, whether a specific predetermined time has elapsed, or whether a predetermined specific times of update of solution nor update of an objective function value has not been made.

The output unit 17 has a function of outputting the obtained solution after the end condition determination unit 16 determines that the optimization calculation has been finished. The output may be performed by a method of various kinds such as by presenting a result on a screen and by outputting in a file. Ways to input the output to a larger system include outputting the result to the system by communication or the like.

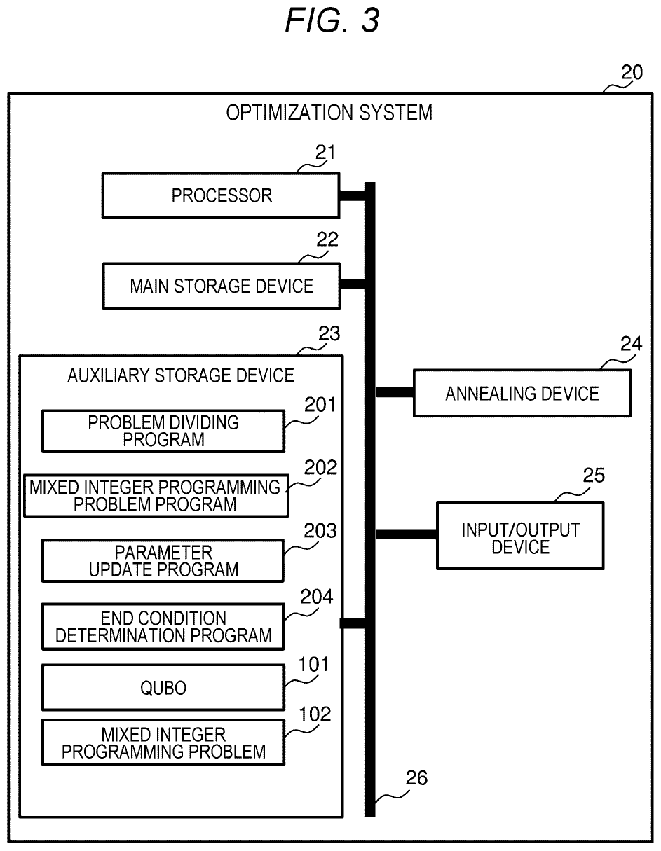

FIG. 3 is a diagram illustrating hardware of a computer that implements the optimization system 20 according to the embodiment.

The optimization system 20 includes, as hardware, a processor 21, a main storage device 22, an auxiliary storage device 23, an annealing device 24, an input/output device 25, and a system bus 26 that communicably connects these devices.

For example, part or all of the optimization system 20 may be implemented using a virtual information processing resource such as a cloud server provided by a cloud system. The optimization system 20 may be implemented by, for example, a plurality of information processing devices that operate in cooperation with each other and are communicably connected.

The processor 21 totally controls the optimization system 20, refers to data in the main storage device 22, and executes a program loaded in the main storage device 22. For example, the processor 21 includes a central processing unit (CPU) or a micro processing unit (MPU).

The main storage device 22 is a volatile storage device that stores a program and data. Examples of the volatile storage device include a read only memory (ROM), a static random access memory (SRAM), a non-volatile RAM (NVRAM), a mask read only memory (ROM), a programmable ROM or the like (PROM), a random access memory (RAM), and a dynamic random access memory (DRAM).

The auxiliary storage device 23 is a nonvolatile mass storage device and is, for example, a hard disk drive (HDD), a flash memory, a solid state drive (SSD), and an optical storage device (compact disc (CD), digital versatile disc (DVD)). The program and data stored in the auxiliary storage device 23 are read into the main storage device 22 as needed.

In the auxiliary storage device 23, a problem dividing program 201, a mixed integer programming problem program 202, a parameter update program 203, and an end condition determination program 204 are installed. The problem dividing program 201, the mixed integer programming problem program 202, the parameter update program 203, and the end condition determination program 204 are programs that execute the functions of the problem dividing unit 12, the mixed integer programming problem optimization unit 14, the parameter update unit 15, and the end condition determination unit 16, respectively.

The auxiliary storage device 23 stores the QUBO equation 101 and the mixed integer programming problem 102.

The annealing device 24 is a device that has a function of the annealing unit 13 and executes processing related to searching of an optimal solution of a combinational optimization problem. For example, the annealing device 24 may take a form of an expansion card to be mounted on the optimization system 20 like a graphic processing unit (GPU). The annealing device 24 includes, for example, hardware such as a complementary metal oxide semiconductor (CMOS) circuit, a field-programmable gate array (FPGA), and an application specific integrated circuit (ASIC).

The annealing device 24 includes a control device, a storage device, and an interface for connecting to the system bus 26, and transmits and receives commands and information to and from the processor 21 via the system bus 26. The annealing device 24 may be, for example, communicably connected to another annealing device 24 via a communication line to cooperate with another annealing device 24. The function implemented by the annealing device 24 may be implemented by, for example, the processor 21 executing a program.

The input/output device 25 includes a user interface that receives an input of information from a user and a user interface for outputting a calculation result. Examples of the input device include a keyboard, a mouse, a card reader, and a touch panel. The output device is, for example, a display device (liquid crystal display (LCD), graphic card, etc.) that visualizes various types of information, an audio output device (speaker), or a printing device. The input/output device 25 performs functions of the problem input unit 11 and the output unit 17. Instead of the input/output device 25, an input device and an output device may be separately provided.

In the optimization system 20, the program is read from the auxiliary storage device 23 and executed by cooperation of the processor 30 and the main storage device 22 to perform the function of the optimization system 20. Alternatively, the program for implementing the function of the optimization system 20 may be acquired via communication from an external computer. Alternatively, the program for implementing the function of the optimization system 20 may be recorded in a portable recording medium (an optical disk, a magnetooptical disk, a magnetic optical disk, a semiconductor storage medium, etc.) and read by a medium reading device.

The optimization system 20 may be an information processing system in which a plurality of devices cooperatively execute processing. The program for implementing an optimization system causes each program to implement the function of each device, whereby the same function as that of the optimization system 20 is implemented.

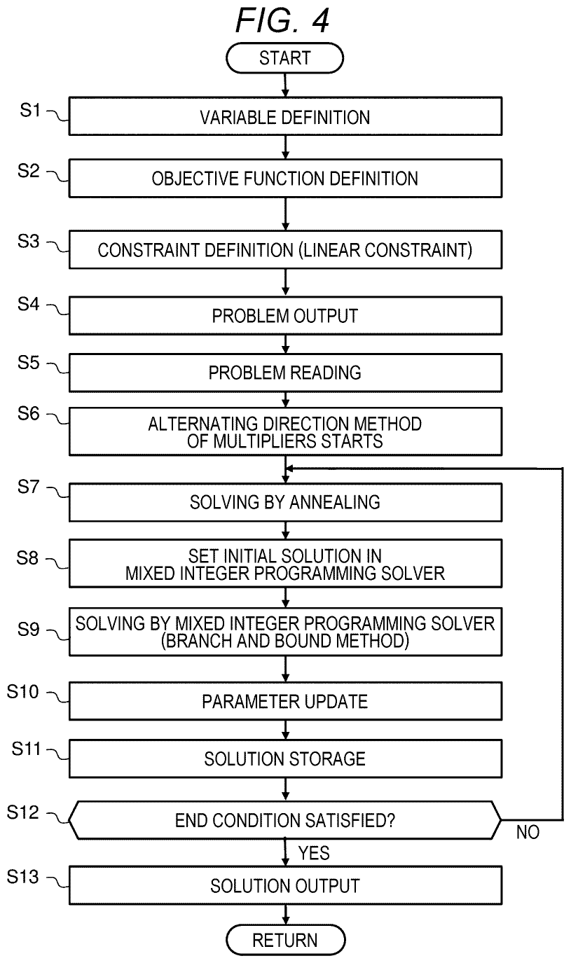

FIG. 4 illustrates the total flow of the optimization processing.

First, variable definition S1 is performed. A variable is an amount or an index to be optimized in the optimization problem, and is x in Equation 1 to Equation 7.

Next, objective function definition S2 is performed. The target to be optimized is defined as an objective function by a mathematical formula using a defined variable. Next, constraint definition S3 is performed. A constraint condition is expressed in a form of a linear constraint. Generally, a constraint of an optimization problem in the real world is often described in a natural language, so that a constraint is defined by an expression of a mathematical formula.

The variable definition S1, the objective function definition S2, and the constraint definition S3 are performed by the input/output device 25 that performs the function of the problem input unit 11 of the optimization system 20.

Now the objective function and the constraint condition of the problem are defined, problem output S4 for optimization is performed. What is output is a QUBO and mixed integer programming problem.

The problem output S4 is performed in the problem dividing unit 12 implemented by the processor 21 reading the problem dividing program in the optimization system 20 for the problem input by the problem input unit 11, and outputs the QUBO equation 101 and the mixed integer programming problem 102.

Next, problem reading S5 of reading the problem by an optimization program is performed. The QUBO equation 101 and the mixed integer programming problem 102 output in a file as an example of the problem reading S5 are developed on the auxiliary storage device 23 in this flow. Next, an optimization procedure is initiated to start the alternating direction method of multipliers (S6). As the first step of the alternating direction method of multipliers, solving by annealing is performed (S7). In this step, the optimization calculation described in Equation 12 is performed by annealing. Solving by annealing S7 is performed by the annealing device 24 of the optimization system 20.

Next, an initial solution is set in the mixed integer programming solver (S8). Then, solving by the mixed integer programming solver is performed (S9).

The processes S8 and S9 involving the mixed integer programming solver are performed, after the mixed integer programming problem 102 is read, by the mixed integer programming problem optimization unit 14 implemented by the processor 21 reading the mixed integer programming problem program 202 in the optimization system 20.

When a predetermined number of solutions are found by the mixed integer programming solver, parameter update S10 is performed. Then, the obtained solution is stored (S11). Handling of a predetermined number of solutions in the present application includes all conceivable methods such as a method of storing only the first obtained solution, a method of storing all of a plurality of obtained solutions, and a method of storing only the best solution among the obtained solutions.

The parameter update S10 and the solution storage S11 are performed by the parameter update unit 15 implemented by the processor 21 reading the parameter update program 203 in the optimization system 20.

After the solution is stored, whether the condition for ending the iterative calculation of the alternating direction method of multipliers has been satisfied is determined (S12). In the determination, it is preferable to use a condition considering a predetermined number of iteration, a predetermined upper limit of calculation time, a predetermined residual error, or the like, or a combination thereof. If the end condition has not been satisfied, the iterative calculation of the alternating direction method of multipliers is continued, and the solving by annealing S7 is performed again. When the end condition has been satisfied, the process proceeds to solution output S13. In the solution output, all the constraint satisfying solutions may be output or a single best solution may be output. These are designed according to the requirement to be satisfied by an optimization system.

The determination S12 of the end condition is performed by the end condition determination unit 16 implemented by the processor 21 reading the end condition determination program 204 in the optimization system 20.

Next, an operation for obtaining an optimal solution (converged solution) will be described.

An optimal solution (converged solution) of a mixed binary quadratic programming problem having a constraint condition is searched.

The annealing unit 13 performs a first search for an annealing solution that lowers the value of the objective function of the mixed binary quadratic programming problem. The mixed integer programming problem optimization unit 14 decreases the value of the objective function of the linear expression and performs the second search for a constraint satisfying solution satisfying the constraint condition.

The annealing unit 13 uses the first solver to perform the first search for an annealing solution through lowering of the objective function value in the neighborhood of the constraint satisfying solution. The mixed integer programming problem optimization unit 14 uses the second solver to perform the second search for the constraint satisfying solution through lowering of the value of the objective function of the linear expression in the neighborhood of the annealing solution obtained by the annealing unit 13. Then, iterative processing of the first search and the second search is performed to obtain an optimal solution (converged solution).

For example, the mixed integer programming problem optimization unit 14 performs the second search using a mixed integer programming solver that operates as the second solver based on an algorithm having a function of minimizing the value of the objective function. The annealing unit 13 uses simulated annealing as the first solver, but the first solver may be another metaheuristic algorithm that heuristically searches for a solution (approximate solution) close to a solution that minimizes the value of the objective function.

Here, an operation of searching ranges of which state and energy are close and updating the next solution is referred to as a neighbor search. An optimal solution (converged solution) is obtained by alternately iterating the first search of searching for a low energy solution in the neighborhood of the solution obtained by the mixed integer programming solver and the second search for a constraint satisfying solution through lowering of the value of the objective function of a linear expression in the neighborhood of the solution obtained by annealing.

As described above, in the above embodiment, the QUBO is solved by annealing, and a constraint that is difficult to be solved at a high speed by annealing, a linear programming solver, or an existing continuous optimization algorithm is handled as a mixed integer programming problem to be satisfied by the second solver (mixed integer programming solver using a branch and bound method, for example).

In the annealing, a solution is searched that lowers the objective function value in the neighborhood of the solution obtained from the solution of the mixed integer programming solver, and the mixed integer programming solver searches for a solution satisfying the constraint through lowering of the value of the objective function of a linear expression in the neighborhood of the solution obtained by annealing. This is alternately iterated to obtain a final constraint satisfying solution.

As described above, according to the above embodiment, a high-quality solution is derived at a high speed for a mixed binary quadratic programming problem having a linear constraint that is difficult to be satisfied by annealing alone. In addition, by not performing linear relaxation for integer variables to handle the integers to maintain their integer properties, convergence to an optimal solution can be sped up also in the second block by considering the linear objective function in the second block of ADMM.

The above embodiment is applicable to, for example, compressed sensing or feature selection.

What is claimed is:

1. An optimization system that searches for an optimal solution of a mixed binary quadratic programming problem having a constraint condition, the optimization system comprising:
an annealing unit that performs a first search for an annealing solution through lowering of a value of an objective function of the mixed binary quadratic programming problem; and
a mixed integer programming problem optimization unit that performs a second search for a satisfying solution satisfying the constraint condition through lowering of a value of an objective function of a linear expression in the mixed binary quadratic programming problem as the mixed integer programming problem, wherein
the annealing unit
performs using a first solver the first search for the annealing solution through lowering of the value of the objective function in a neighborhood of the satisfying solution,
the mixed integer programming problem optimization unit
performs using a second solver the second search for the satisfying solution in a neighborhood of the annealing solution obtained by the annealing unit, and
iterative processing of the first search and the second search is performed to obtain the optimal solution.

2. The optimization system according to claim 1, wherein
the mixed integer programming problem optimization unit performs the second search using a mixed integer programming solver that operates as the second solver based on an algorithm having a function of minimizing the value of the objective function.

3. The optimization system according to claim 1, wherein
the mixed integer programming problem optimization unit
ends the second search when a predetermined number of satisfying solutions are found.

4. The optimization system according to claim 1, wherein
the mixed integer programming problem optimization unit
ends the second search when a predetermined time for searching solution elapses.

5. The optimization system according to claim 1, further comprising:
a problem input unit;
a problem dividing unit;
a parameter update unit;
an end condition determination unit; and
an output unit, wherein
the problem input unit
inputs the mixed binary quadratic programming problem,
the problem dividing unit
divides the mixed binary quadratic programming problem input by the problem input unit into a QUBO equation to be solved by the annealing unit and an objective function of a linear expression and a constraint expression to be solved by the mixed integer programming problem optimization unit, and outputs the QUBO equation, the objective function, and the constraint expression,
the annealing unit
performs the first search for the annealing solution using the QUBO equation,
the mixed integer programming problem optimization unit
performs the second search for a constraint satisfying solution using the objective function of a linear expression and the constraint expression,
the parameter update unit
updates a predetermined parameter and feedbacks the parameter to the annealing unit and the mixed integer programming problem optimization unit,
the end condition determination unit
determines, based on a predetermined end condition, whether to end the iterative processing of the first search and the second search based on a result of the parameter update unit,
when it is determined, based on the predetermined end condition, that the iterative processing is not to be ended, the iterative processing of the first search by the annealing unit and the second search by the mixed integer programming problem optimization unit is performed, and
when it is determined, based on the predetermined end condition, that the iterative processing is to be ended, the optimal solution is output to the output unit.

6. The optimization system according to claim 5,
the problem input unit
performs conversion processing of converting the mixed binary quadratic programming problem into an augmented Lagrangian function having a first variable vector and a second variable vector including the objective function, the constraint expression, and a penalty term based on the constraint expression, as a variable,
the problem dividing unit
converts the objective function and the penalty term into the QUBO equation, transmits the QUBO equation to the annealing unit, and transmits the objective function of a linear expression and the constraint expression to the mixed integer programming problem optimization unit,
the annealing unit
searches for an optimal solution of the first variable vector that optimizes the augmented Lagrangian function in an alternating direction method of multipliers using a predetermined optimization algorithm of an unconstrained mixed binary quadratic programming problem,
the mixed integer programming problem optimization unit
searches for an optimal solution of the second variable vector that optimizes the augmented Lagrangian function in the alternating direction method of multipliers for the objective function of the linear expression using the mixed integer programming solver to satisfy the constraint expression, and
the parameter update unit
updates the parameter of the augmented Lagrangian function and feedbacks the parameter to the annealing unit and the mixed integer programming problem optimization unit.

7. The optimization system according to claim 5, wherein
the end condition determination unit
has the predetermined end condition that is iteration of the iterative processing by a predetermined number of times.

8. The optimization system according to claim 5, wherein
the end condition determination unit
has the predetermined end condition that is iteration of the iterative processing until a predetermined time elapses.

9. An optimization method for searching an optimal solution of a mixed binary quadratic programming problem having a constraint condition, the method comprising:
a first step of an annealing unit performing a first search for an annealing solution through lowering of a value of an objective function of the mixed binary quadratic programming problem; and
a second step of a mixed integer programming problem optimization unit performing a second search for a satisfying solution satisfying the constraint condition through lowering of a value of an objective function of a linear expression in the mixed binary quadratic programming problem as the mixed integer programming problem, wherein
in the first step,
the first search for the annealing solution is performed using a first solver through lowering of the value of the objective function in a neighborhood of the satisfying solution,
in the second step, and
the second search for the satisfying solution is performed using a second solver in a neighborhood of the annealing solution obtained by the annealing unit, and
iterative processing of the first search and the second search is performed to obtain the optimal solution.

10. An optimization program that searches for an optimal solution of a mixed binary quadratic programming problem having a constraint condition, the optimization program being configured to cause a computer to execute
an annealing function that performs a first search for an annealing solution through lowering of a value of an objective function of the mixed binary quadratic programming problem, and
a mixed integer programming problem optimization function that performs a second search for a satisfying solution satisfying the constraint condition through lowering of a value of an objective function of a linear expression in the mixed binary quadratic programming problem as the mixed integer programming problem, wherein
the annealing function
performs using a first solver the first search for the annealing solution through lowering of the value of the objective function in a neighborhood of the satisfying solution,
the mixed integer programming problem optimization function
performs using a second solver the second search for the satisfying solution in a neighborhood of the annealing solution obtained by the annealing unit, and
iterative processing of the first search and the second search is performed to obtain the optimal solution.
